(19) United States
(12) Patent Application Publication
(10) Pub. No.: US 2007/0133348 A1
(43) Pub. Date: Jun. 14, 2007

(54) Remuage - riddling machine

(76) Inventor: Oleg Naljotov, Brooklyn, NY (US)

Correspondence Address: Oleg Naljotov, 3130 Brighton 6th Street, #5D, Brooklyn, NY, 11235, US

(21) Appl. No.: 11/543,448

(22) Filed: Oct. 4, 2006

Related U.S. Application Data
(63) Continuation-in-part of application No. 11/453,517, filed on Jun. 15, 2006.
Application No. 11/453,517 is a continuation-in-part of application No. 10/453,074, filed on Jun. 3, 2003, now abandoned.

(51) Int. Cl. B01F 9/02; B01F 11/00

(52) U.S. Cl. 366/213

(57) ABSTRACT

A riddling machine for intensification of depositing lees in wine is provided. One embodiment comprises a first and a second row of struts respectively supporting pivotable gearboxes and supporting boxes, between which inclined shafts are disposed, and rotatable by a revolving motor through a common shaft, extending through the gearboxes, and by gears contained in the gearboxes. The inclined shafts' tilt is variable by an angular motor driving an angle-transmitting disk and the common shaft, further turning the gearboxes fixedly securing lateral bearings that support the inclined shafts from first ends. Second ends of the inclined shafts are supported by lateral bearings fixedly mounted in the supporting boxes, which are optionally attached to the second row struts by flexible suspension members. Each pair of the inclined shafts supports and revolves at least one bottle of wine. Most embodiments include control means to actuate said motors. Some embodiments comprise vibrating means.

### CROSS REFERENCE TO RELATED APPLICATIONS

This U.S. patent application is a continuation-in-part application of a U.S. patent application Ser. No. 11/453,517 filed on Jun. 15, 2006 (that, in turn, was a continuation-in-part of a U.S. patent application Ser. No. 10/453,074 filed on Jun. 3, 2003, published under the number: 20040244597 A1, now abandoned), which patent application is hereby incorporated by reference in its entirety.

### TECHNICAL FIELD

The present invention relates to the food industry, particularly to the wine industry, and can be used for the riddling stage of champagne production.

### BACKGROUND OF THE INVENTION

The traditional technology of champagne making, particularly described on the web page “http://www.champagne-ayala.fr/fabrication_eng.html#top” includes the following stages: pressing (the grapes are placed in special presses to yield their juice), winemaking (the first fermentation—transformation of sugar into alcohol), blending (blending wines from different vineyards and different harvests), bottling (the second fermentation—in the definite bottle), riddling or remuage (gathering the dead yeast cells or sediment, also known as lies or lees, which are formed during the bottling, and brought to the neck of the bottle during this stage), disgorgement (the bottle necks are frozen, trapping the sediments in a chunk of ice, the bottles are opened, and the sediments are expelled with the ice by the pressure in the bottle).

The riddling stage, intended to make the sediment deposit slide into the neck of the bottle, prescribes: “During 4 to 5 weeks the bottles are placed at a 45 degree angle, stored on racks and are handled, manually or automatically, about 40 times. They are regularly turned (an eighth or a forth of a turn) and progressively brought back up to a vertical position. The mechanical riddling can achieve this in about a week, while the manual riddling takes about one month.”

When Veuve Clicquot first developed the riddling system, every step was done by hand. The complete process took usually from six to eight weeks for a batch of about 5000 bottles. Some producers still use this hands-on method. After the second fermentation in the bottle, and after the aging period on the yeast sediment in the bottle, the bottles are taken from their resting place and inserted into large A-frame wooden racks, called pupitres, with the neck of the bottles pointing slightly downward. The sediment at this stage appears as a strip, with many of the dead yeast cells adhering to the side of the bottle. The riddler is to maneuver the sediment into manageable lump inside the bottle, and then bring the lees down of the bottle into the bottle neck, close to the crown cap closing the bottle.

In order to do this, the following steps are repeatedly performed on each bottle: the riddler manually grasps the bottom end of each bottle; shakes the bottle slightly to dislodge any stuck lees; turns the bottle approximately one-eighth of a turn; raises the bottom end of the bottle slightly; drops the bottle back into the hole in the rack. Such handling of the bottle gradually ousts the sediment into the neck of the bottle, at which point the bottle is almost completely inverted on the rack.

Many of champagne sparking wine producers use modern automated methods to riddle the wine. There are semi-automatic and automatic devices called “gyropalettes”, where a hexagonal metal basket with an inverted cone-shaped base is filled with inverted bottles and occasionally rotated from side to side.

In 1966, Adolf Heck invented and patented the first automatic riddling machine. Korbel has continued to improve upon Adolf's idea, and today it is possible to produce champagne of consistent high quality with the gyropalettes. According to Korbel, the bottled wine is placed upside down in shipping cases that are arranged on automatic riddling racks. These racks gently vibrate the bottles for one hour, four times a day. During the vibration, the cases are gently rocked every two minutes that eventually works the lees down into the neck of the bottle.

Computer-automated gyropalettes accomplish the riddling in batches, using movable bins containing thousands of bottles. Invented in Spain, they became common in all sparkling wine producing countries since the late 1970s. The mechanization allows for saving time, space and production cost for the producers. Hand riddling requires a minimum of eight weeks to complete, whereas the gyropalettes finish the task in less than ten days. This application of modern technology also increases product consistency from bottle to bottle. Production cost savings also has allowed the introduction of traditional method sparkling wines into the lower price end of the market where formerly only bulk produced wines competed.

The present invention further develops ideas and methods demonstrated in the parent application Ser. No. 11/453,517 and the abandoned application Ser. No. 10/453,074 with the purpose of further increasing efficiency and reduction of costs.

### BRIEF DESCRIPTION OF THE PRESENT INVENTION

A riddling machine for intensification of a process of depositing dead yeast cells in the wine technology is provided, according to the present invention. One embodiment of the machine comprises a first and a second row of struts respectively supporting pivotable gearboxes and supporting boxes, between which inclined shafts are disposed. The inclined shafts are rotatable by a revolving motor through a common shaft, extending through the gearboxes, and by gears contained in the gearboxes. The inclined shafts' tilt is variable by an angular motor driving an angle-transmitting disk and the common shaft, further turning the gearboxes. The gearboxes include lateral bearings, fixedly mounted therein, which lateral bearings support the inclined shafts from first ends. Second ends of the inclined shafts are supported by lateral bearings fixedly mounted in the supporting boxes. The supporting boxes are optionally attached to the second row struts by flexible suspension members. Each pair of the inclined shafts supports and is capable to revolve at least one bottle of wine. Most embodiments include control means to actuate said motors. Some embodiments comprise vibrating means.

### BRIEF DESCRIPTION OF THE DRAWINGS

FIG. 1C illustrates a side view of an embodiment of the riddling machine according to the present invention.

FIG. 2C illustrates a front view of the embodiment of the riddling machine shown on FIG. 1C, according to the present invention.

FIG. 3C illustrates a turn-transmitting disk as an element of the embodiment of the riddling machine shown on FIG. 1C, according to the present invention.

FIG. 4C illustrates an upper support and an upper supporting box attached to a strut of the embodiment of the riddling machine shown on FIG. 1C, according to the present invention.

FIG. 5C shows in detail a flexible suspension member as an element of the embodiment of the riddling machine shown on FIG. 1C, according to the present invention.

Generally, the same reference numerals refer to the same elements of construction on different figures. The newly introduced numerals are enclosed into parentheses.

### DESCRIPTION OF THE PREFERRED EMBODIMENT OF PRESENT INVENTION

While the invention may be susceptible to embodiment in different forms, there is shown in the drawings, and will be described in detail herein, specific embodiments of the present invention, with the understanding that the present disclosure is to be considered an exemplification of the principles of the invention, and is not intended to limit the invention to that as illustrated and described herein.

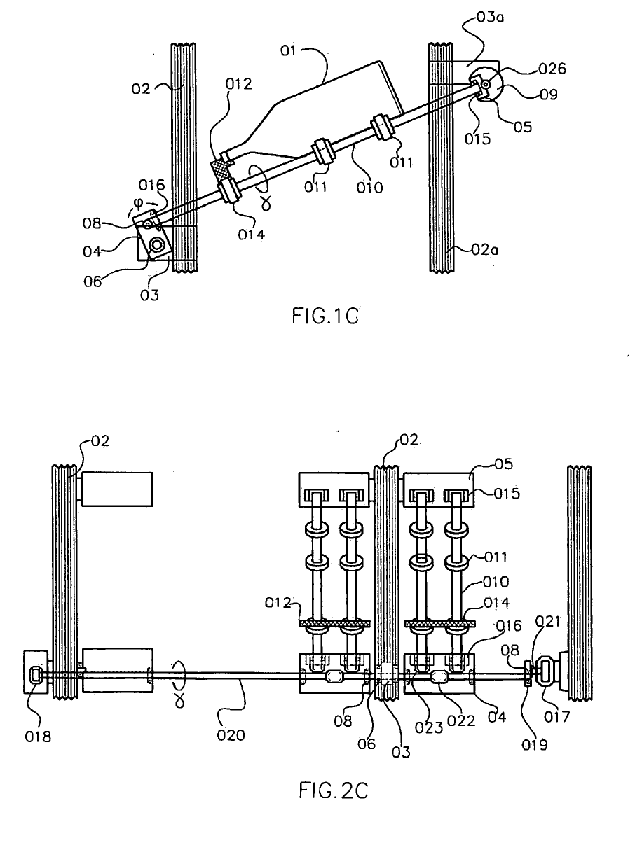

Referring to the drawings illustrated on FIGS. 1C, 2C, an embodiment of the riddling machine comprises a plurality of struts arranged in pairs, wherein said pairs are arranged in two substantially parallel rows: a first row struts (02) and a second row (02a); the struts 02 are fixedly mounted to a base, and disposed substantially vertically. Each strut 02 of the first row is furnished with a lower support (03) fixed in the lower region of the corresponding strut.

The embodiment (shown on FIGS. 1C, 2C) comprises a plurality of lower gearboxes (04) situated in the lower region of the first row struts 02, and an elongated common shaft (020) horizontally extending through the gearboxes 04 supported by common shaft bearings (08). Each gearbox 04, by its side facing the corresponding strut, is pivotally attached to the corresponding lower support 03 by means of an “angle-driven” ball-bearing (06). This allows for angularly turning the gearboxes 04 with the common shaft 020 around the axe of the ball-bearings 06 in the plane perpendicular to the longitudinal axe of the common shaft and relatively to the struts 02.

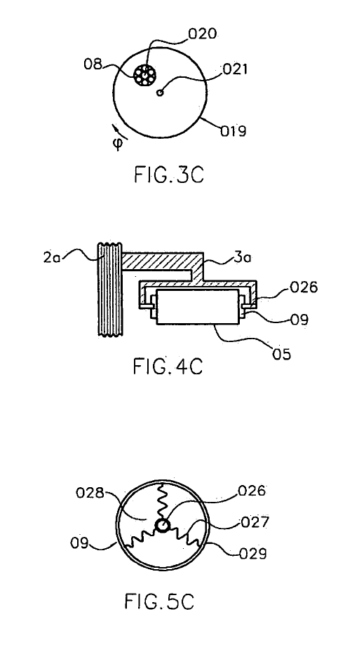

The angularly turn of the gearbox 04 is actuated by an angular motor (017) secured, for example to a first ending strut 02. The angular turn is transmitted to the common shaft 020 through a turn-transmitting disk (019) driven by the angular motor 017. The turn-transmitting disk 019 is depicted in detail on FIG. 3C. One of the bearings 08 is mounted in the disk 019 at a predetermined distance from the center of the disk. The disk 019 is centrally mounted on a motor axis (021) of the angular motor 017.

The common shaft 020 is extending through the bearing 08 of disk 019, the bearings 08 of all gearboxes (04), and is rotatable around its longitudinal axe driven by a revolving motor (018) pivotally mounted to a second ending strut 02 in a fashion similar to the attachment of the gearboxes. Each gearbox 04 includes a pair of common shaft bearings 08 supporting the common shaft therein. Each gearbox 04 includes a group, consisting of a number (preferably a pair as shown on FIG. 2C) of lower lateral bearings (016).

Each strut 02a of the second row, reflected on FIG. 1C, is furnished with an upper support (03a) laterally fixed in the upper region of the corresponding strut 02a. The embodiment comprises a plurality of upper supporting boxes (05), each having two substantially vertical sides disposed in planes perpendicular to the horizontal axe of the box 05. Each upper box 05 includes a group, consisting of a number (preferably a pair as shown on FIG. 2C) of upper lateral bearings (015). Each said substantially vertical side of the upper box 05 is fixedly mounted to a flexible suspension member (09) illustrated in detail on FIG. 5C.

The flexible member 09 is suspended on the corresponding upper support 03a through a suspension axis (026), shown on FIG. 4C. Each flexible member contains a number (preferably three, disposed at a 120.degree angle to each other) of resilient elements, such as coil springs (027), each having an inner end and an outer end. The inner ends of the resilient elements are coupled to an inner ring (028) of the member 09, and the outer ends are coupled to an outer ring (029) of the member 09. The outer ring 029 is fixed to the corresponding vertical side of the upper box 05; the inner ring 028 is pivotally mounted on the suspension axis 026.

The embodiment comprises a plurality of elongated inclined shafts (010) generally disposed to an angle to the horizon. The inclined shafts 010 are arranged in groups each consisting of a number of inclined shafts, preferably in pairs (as shown on FIG. 2C). The lower ends of the inclined shafts 010 are mounted on the lower lateral bearings 016 of the corresponding gearbox 04. The upper ends of the inclined shafts 010 are mounted on the upper lateral bearings 015 of the corresponding supporting box 05. Each inclined shaft 010 is furnished with a number (preferably two) of driving rolls (011) and one supporting roll (014) axially mounted on the inclined shaft.

A neck-supporting lath (012) is slidely disposed on the two supporting rolls 014 of one pair of inclined shafts 010, so that when the rolls 014 rotate, the lath 012 does not substantially change its position. Alternatively, the lath 012 can be fixed to the strut 02 (not shown). A bottle (01), containing wine with lees, is downwardly placed on the driving rolls 011 of the corresponding pair of inclined shafts 010, so that the neck of the bottle 01 is supported by the lath 012.

Each gearbox 04 includes a gear driven by the common shaft and transmitting the rotation to the corresponding pair of inclined shafts, thereby the revolving motor is enabled to drive the inclined shafts. The gear exemplarily may be performed as a conical tooth gearing (022) and (023), as schematically shown on FIG. 2C. A regulative clutch (not shown herein) may be provided to engage and disengage the driving 022 and driven 023 parts of the gear. The gear should be so configured to provide the revolving of the inclined shafts 010 of one group (one pair in the given example) in one direction to allow for efficient revolving of the bottle placed upon the shafts 010.

The angular motor 017 and the revolving motor 018 are preferably controlled by a control unit (not shown in the drawings herein) including a computer capable of executing a computer program, coded according to the rules of turning the bottles on the inclined shafts and changing the angle of the inclined shafts, as required by the riddling technology.

The riddling machine of the described above embodiment operates as follows. The operator activates the aforesaid computer program that substantially automatically controls the process. At a certain time the machine actuates the revolving motor 018 driving the common shaft 020. The rotation of the common shaft 020 is transmitted through the gears of the gearboxes 04 to the inclined shafts 010, which revolves the inclined shafts 010 thereby turning the bottle 01 at a desired angle “gamma” (see FIG. 1C) around its longitudinal axe. As required by the riddling technology, at another time the machine initiates the angular motor 017, which actuates an angular turn of the turn-transmitting disk 019 turning the common shaft 020 with all the gearboxes 04 at a certain angle “phi” relatively to the horizon.

The embodiment of the riddling machine may equally change the angular “gamma” and “phi” positions of all the bottles installed on it, which is required at certain times by the wine technology for intensifying the depositing process.

Ramifications of the Invention

Some embodiments may include a vibrator (not shown), for example actuating vibrations of the struts with the inclined shafts, holding the bottles, additionally intensifying the depositing process. The vibrator is preferably controlled by the control unit (not shown) regulating the vibrations according to a program to satisfy technological requirements.

In other embodiments the variations of angles “phi” may be arranged through the use of a tilted base, supporting the struts, whose tilt can be regulated by a control system. In such embodiments the angular motor, the angle-transmitting disk, the “angle-driven” ball-bearings, and the flexible suspension members may be partially needed or not be needed at all.

Other embodiments may provide means (not shown) for a horizontal or vertical movement of the suspension member along the upper support of the second row strut. Yet other embodiments may provide means (not shown) for a horizontal movement of the second row struts relative to the first row struts or vice-versa. The gearboxes may be mounted on the second row struts (from the upper side) together with the common shaft and, and the supporting boxes would therefore be located on the first row struts (on the lower side) with or without the flexible suspension members. In some embodiments, the second row of struts may not be used at all, so that the inclined shafts would be supported only by the lower lateral bearings, secured in the gearboxes.

Other embodiments may include an elongated member (e.g. a rod—not shown) adapted to the shape of the bottle, attached, for instance, to the lath, and extending parallel to the inclined shafts (preferably in the middle and above) so that additionally securing the bottle placed on the driving rolls of the inclined shafts while they're positioned at angles “phi” close to vertical. If needed, the number of inclined shafts holding one bottle can be more than two. Also in other embodiments, a plurality (more than one) of bottles (not shown) can be placed on the pair of the inclined shafts, with the use, for example, similar separating laths.

I claim:

1. A riddling machine for intensification of a process of depositing dead yeast cells in a plurality of bottles of wine, said riddling machine comprising:
supporting means;
a plurality of inclined shafts substantially mounted at a variable angle “phi” to the horizon on said supporting means, the inclined shafts arranged into groups, each group capable to support and revolve at least one of said plurality of bottles at an angle “gamma” within a predetermined limit; the plurality of inclined shafts substantially supported by the supporting means;
revolving means substantially supported by said supporting means and configured to substantially provide the revolving of said plurality of inclined shafts around their longitudinal axes; and
angular variation means substantially supported by said supporting means and configured to substantially provide the variations of the angle “phi”.

2. The riddling machine according to claim 1, wherein
said revolving means comprising revolving motor means and revolving gear means actuating the revolving of said plurality of inclined shafts;
said angular variation means comprising angular motor means and angular transmission means actuating the variations of the “phi” angle of said plurality of inclined shafts; and
the riddling machine further comprising
a common shaft substantially transmitting the “phi” angle variations from the angular motor means to the angular transmission means, and substantially transmitting the rotations of the revolving motor means to the revolving transmission means.

3. The riddling machine according to claim 2, wherein
the supporting means comprising a plurality of gearboxes configured to contain said revolving transmission means and to provide the transmission of the “phi” angle variations from the common shaft to said plurality of inclined shafts; each gearbox comprising first lateral bearing means capable to support and provide rotation of first ends of the inclined shafts of one said group; and
the supporting means comprising a plurality of supporting boxes each comprising second lateral bearing means capable to support and provide rotation of second ends of the inclined shafts of one said group.

4. The riddling machine according to claim 3, wherein
the supporting means comprising a plurality of supporting struts arranged into two rows: the struts of a first row and the struts of a second row;
each said gearbox substantially supported by the struts of the first row;
the supporting means comprising a plurality of flexible suspension members each including
an outer ring fixedly connected substantially to one of the struts of the second row,
an inner ring fixedly connected substantially to the corresponding said supporting box, and
a resilient element attached by its first end to the outer ring, and by its second end to the inner ring.

5. The riddling machine according to claim 1, further comprising
control means configured to control said revolving means and said angular variation means according to requirements of said process.

6. The riddling machine according to claim 5, further comprising
vibration means capable to provide vibration of the bottles placed on the riddling machine; said vibrations regulated by the control means.
